(19) United States
(12) Patent Application Publication
(10) Pub. No.: US 2012/0293307 A1
(43) Pub. Date: Nov. 22, 2012

(54) RFID systems having improved read rates for localization and proximity detection

(75) Inventors: Petar M. Djuric, Setauket, NY (US); Miodrag Bolic, Ottawa (CA); Akshay Athalye, Port Jefferson Station, NY (US)

(73) Assignee: Astraion, LLC, Stoney Brook, NY (US)

(21) Appl. No.: 13/474,113

(22) Filed: May 17, 2012

Related U.S. Application Data
(60) Provisional application No. 61/519,050, filed on May 17, 2011.

(51) Int. Cl. G06K 7/01

(52) U.S. Cl. 340/10.2

(57) ABSTRACT

We describe RFID systems for localization and proximity detection and with improved read rates. The systems include three components, (a) RFID readers, (b) passive and/or semipassive tags, (c) sensor-tags (STs), (d) STs integrated with sensors, and (e) and processing elements. The key new elements are the STs, which are like regular tags that communicate with RFID readers on the principle of backscattering. However, they have an additional functionality of reading the communication of standard tags in their physical proximity and reporting it, if queried, to an RFID reader or a processing element. They can also use other types of communication with the RFID readers and processing elements. These functionalities allow for a variety of new solutions to many RFID problems some of which are described in this document.

### CROSS-REFERENCE TO RELATED APPLICATIONS

This application claims the benefit under 35 U.S.C. §119 [symbol] of U.S. Provisional Application Ser. No. 61/519,050, filed on May 17, 2011, which is hereby incorporated by reference herein in its entirety.

### FIELD OF THE INVENTION

The present invention relates to new Radio Frequency Identification (RFID) systems with applications to localization, proximity detection, and with improved read rates: Some specific applications of the systems include (a) object location and tracking (e.g., in warehouses and distribution centers, hospitals (patients and equipment), airports (equipment and baggage), libraries (books, DVDs and other items), stores (merchandise), offices (various tagged documents), and factories), (b) proximity detection (e.g., detection of contraindicated route of drug administration in hospitals and determination of interactions between humans and objects), and harvesting of data for business intelligence (e.g., in stores and hospitals), (c) determination of direction of motion (e.g., portal-based RFID systems), (d) location-based RFID tag filtering (prevention of reading tags in unwanted areas and recording of tags only in designated areas).

### BACKGROUND

U.S. Pat. No. 7,812,719 relies on a special landmark tag called sensor-tag (ST) that can sense the presence of other tags in real-time and communicate the ST's ID numbers to the reader in real-time. The patent is limited in its applications to localization and tracking of passive and semipassive tags and in ways how localization and tracking are accomplished. The methods rely on detecting backscattered signal from RFID tags by STs placed at fixed known locations and using backscattering to communicate the detected information from the ST to the RFID reader. The patent does not cover situations where STs can be localized or in which STs can communicate with a processing unit using other types of communication protocols (non-RFID based). In addition, the patent does not cover applications of STs such as proximity detection, prevention of unwanted reads, improving read rates of passive RFID systems, and applications with STs that are integrated with sensors.

A fundamental attribute of asset visibility is asset location. Today's passive and semi-passive RFID systems are incapable of determining the precise location of tagged objects or to detect their proximity. Passive and semi-passive RFID tags communicate with the reader via weak reflected backscatter. This backscatter is further affected by multipath reflections and other ambient interferences in cluttered indoor environments like warehouses, retail stores, libraries, and offices. Hence, conventional location techniques become highly inaccurate and unreliable in the context of passive and semi-passive RFID systems.

One can view tracking as a dynamic version of localization, where the objective is to localize dynamic objects, that is, objects that change their location with time. In principle, one can argue, that this is a more difficult problem than localization but the underlying methodologies that have been in use are more or less the same as those for localization. Therefore, the problems that arise from the physics of the system remain the same as for the problem of localization. Most of the methods compare the received signal strength (RSS) of the desired tag with the RSS of landmark tags with known locations. All of these methods suffer from unreliable readings due to the multipath environment, which reflects on the accuracy of the tracking.

RFID has already been used for detection of proximity and interactions in health as well as in robotics. There, short-range readers are attached to the hands of monitored people and all the interactions with tagged objects are detected and recorded, thereby allowing for monitoring activities.

Proximity detection has been used for making inference about interaction among people. Typically, face-to-face interactions are determined based on using active RFID technology. Active RFID tags are worn as badges. The tags do not only broadcast signal that is received by the reader but also exchange messages in peer-to-peer fashion to detect neighbor tags. Tags transmit messages at different power levels. Low power level is used to communicate with tags in their proximity while higher power messages are sent to the reader when tags in proximity detect other tags. This method does not support passive and semi-passive RFID systems and it is limited to assessing interaction among people. It, too, does not cover a wide range of applications presented in the patent.

U.S. Pat. No. 8,140,014 B2 presents a device and a method for detecting social interactions. The method is based on detecting in-range wireless devices, detecting if level and duration of proximity are within predefined range and obtaining and storing identification information from in-range device. The claims do not specify a type of wireless devices and does not cover any issues related with backscattering of passive and semipassive tags. It does not include a way to communicate proximity detection information because it is assumed that communication will be easily achieved using conventional wireless networks such as Bluetooth and WiFi. However, this is not the case with passive and semipassive RFID systems. Also, it does not cover a wide range of applications presented in this patent.

U.S. Pat. No. 7,986,235 describes a system in which distributed RFID receivers are capable of receiving tags' signals, decoding them and transferring decoded information using either wired or wireless connection to a primary RFID reader. A major application of this system is to relieve the primary reader of a number of receiving tasks. The patent does not provide any other use of the system.

A major shortcoming of today's commercial passive RFID systems is the low percentage of successful tag reads. This is commonly referred to as the low read rate or low read accuracy problem. It implies that a reader fails to read all the passive tags present in its interrogation field. Reports on typical read rates of today's passive RFID systems show that the read rates range from 60% to 85%, where the rate depends on the application and the deployment environment. The missed or unsuccessful tag reads are caused in part by the weak backscatter and the challenging deployment environments. Other factors include reader antenna configuration and tag orientation. Low read rates have proved to be a prohibitive factor in the widespread adoption of passive RFID.

U.S. Pat. No. 7,606,530 B1 describes a system for extending the read range of RFID systems. The system includes a repeater that can retransmit a signal from the reader in addition to retransmitting the signal from the tag. The system of this patent is different in that it improves the read rates of passive/semipassive tags that are able to receive the signal from the reader but the reader is not able to properly decode the backscattered signals from the tags.

U.S. Patent No. 2007,0,229,280 presents a system for improving read rates containing multiple antennas that can be used for first detecting the position of the tag and then for selecting the antenna that is closest to the tag for further interrogation of the tag. To be efficient, this system requires a large number of RFID reader antennas.

An important task in many RFID systems with gates (e.g., portals) is estimating the tag movement direction for the purpose of business management (e.g., inventory or document management). Such systems can also be used for detecting undesirable objects or preventing theft. The usual solution for estimating tag movement direction is to place sensors at the gates at the entrance and exit sides. The direction of movement is estimated by the difference in times when the sensors detected the tags. These systems require, however rather expensive equipment. Another typical solution is based on using multiple antennas. For estimation of the direction of movement one uses the read count and the received power and transmission delay obtained by the antennas. None of the existing systems employ STs for the direction of tag movement. The STs have the ability to provide information that can allow the system to unambiguously estimate the direction of movement. Detection of movement is described in U.S. Patent 2010,0,156,651. The patent describes using phase angle and/or RSSI values to determine movement of tags in backscattered RFID systems.

There are several problems in using RFID for portal applications such as: (1) read-accuracy (2) cross-reading of tags and (3) determining direction of movement of tagged objects through the portal. The read accuracy is the percentage of tags moving through the portal that are correctly read and identified by the portal reader. Cross-reading represents unwanted reads of tags that do not go through the portal. Ideally, one would like to achieve zero cross-reads and 100% read accuracy. Read-accuracy is the most important factor for RFID dock door systems. With the RFID passive tag, the read-accuracy depends on the amount of power the reader is able to deliver to passive tags. In order to improve the read accuracy, the power at the output of the reader antenna is increased which results then in increased number of cross-readings. So, high read accuracy and zero cross-reads are conflicting requirements.

To reduce cross-reading, several systems adapt “read it when you need it” concept, in which readers antennas are turned on only when needed. The concept can be further extended in systems with multiple dock doors to ensure that the reader in only one dock door is active at a time. Another solution involves setting simple time thresholds to ignore appearances of tags that are too short or have too low RSSI. Some approaches are based on the use of RSSi data, along with the phase angle of the received RF wave, which changes over time to calculate whether a tag is in motion and whether it is near the reader, in a particular zone.

Unwanted reading problems exist in other applications such as dock doors, RFID cabinets, and RFID-based smart shelves. For example, an RFID cabinet presented in the U.S. Pat. No. 7,348,884 addresses problems of unwanted reads using cabinets made of material that can confine RF fields generated by the reader within the interior of the cabinet.

### SUMMARY

A new RFID system with a set of wide range of applications is disclosed. The system includes RFID reader, passive/semipassive tags, passive/semipassive STs, passive/semipasive STs integrated with sensors (STs-is), and a processing element. The applications include localization, tracking, proximity detection, reducing unwanted reads, detection of direction of movement of objects or of people, and making inference from sensor data.

The RFID reader initiates the communication with the tags and the STs. The tags are either attached to objects or people that need to be identified or serve as landmark tags. They communicate with the RFID reader using backscatter modulation. The STs have the functionality to sense the communication between tags that are in their vicinity and the RFID reader. The communication from the STs to the reader can be based on backscatter modulation or using wireless communication protocols not based on backscatter modulation or by communicating through a wired link. If the ST does not use backscatter modulation to communicate its information, it can communicate it directly to the processing element. The information from the ST combined with that received from regular tags is used in different ways and depends on the specific application. The STs can have integrated sensors in which case we refer to them as ST-is.

In one embodiment, the RFID components (tags or STs) are used as infrastructure components (landmark tags). The components are affixed at known locations and ST components (STs or ST-is) are attached to objects or people that need to be located. The location and tracking of the object or people is obtained from the information collected by the ST components which comprises the detected landmark tags and their known locations.

When the processing of the collected information from the previous embodiment is carried out sequentially in time, the system can perform tracking and estimation of direction of movement of the objects or people. At a given time instant, the location of the desired object or person is determined. At the next time instant, from a new set of data, the location of the object or person is determined again, and so on. From the sequence of estimated locations, the system determines the direction of movement, or if there is a movement at all.

In another embodiment, the system is used to prevent unwanted reads. For example, in areas with several congested portals, one wants to read objects or people who pass only through a given portal. The system achieves this by having ST components placed at strategic places from which they can sense RFID components passing through the portal.

A set of embodiments is related to proximity detection. The system can be used to detect proximity between people and objects, among objects themselves, or among people themselves. STs are placed on objects or people that may or may not move, and they collect information that is used to determine the people and objects that are in proximity to each other.

Also disclosed is an embodiment where the proximity detection is used for monitoring the dynamics of social interactions. When the STs report the detected STs in their neighborhood sequentially in time, from the patterns of detected neighbors one can readily deduce for how long a given object or person was in proximity of any given object or person that is being monitored.

There are also embodiments related to ST-is. STs-is have the additional functionality to read and process measurements of sensors that are integrated with them. The tasks of localization, proximity detection, detection of movement, and reducing unwanted tags can be improved with the readings of the sensors. The STs-is can process the information of the sensors and send the processed information to the RFID reader or directly to the processing element. In one embodiment, the information is sent via backscatter modulation and in another, by non-RFID protocols.

In another embodiment, the STs are used to improve read rates of passive and semipassive RFID systems. RFID systems are usually implemented as single hop networks and they operate in star configurations. A system with STs offers new possibilities because they have capabilities to listen to the responses of other tags and to store the responses in their internal registers. This feature can be used in situations where communication between the reader and the tag fails and particularly in situations when the signal from the reader is strong enough to wake the tag but the backcattered signal by the tag is too weak to be detected correctly by the reader.

The STs can also be used in a setup where tags talk first. An RFID reader does not send query signals to tags but instead emits a continuous wave that is harvested by the passive tags near the reader, and they start responding to the reader. Most likely, because of the multiplicity of tags, the reader will not be able to read the responding tags. The STs instead will experience much less interference from the responding tags, and they will be able to store the information from the tags. Following a protocol that alleviates interference of the ST signals, they will then forward the stored information to the RFID reader. The STs can also send their information to the data processing element by a supported wired or wireless protocol.

### BRIEF DESCRIPTION OF THE DRAWINGS

The invention is described in detail by way of examples and with reference to the following drawings:

FIG. 1 displays a block diagram of an overall system that includes an ST, a tag, an RFID reader, and a data processing element.

FIG. 2 displays a block diagram of an ST.

FIG. 3 displays a setup and a system for localization of STs using RFID tags placed at known locations.

FIG. 4 displays a setup and a system for detecting proximity between people and objects and proximity among objects.

FIG. 5 displays a setup and a system for detection of unwanted reads applied to a portal application.

FIG. 6 displays an algorithm for determining proximity.

FIG. 7 displays an algorithm for localization.

FIG. 8 displays a method for improving read rates.

### DETAILED DESCRIPTION OF THE INVENTION

The following detailed description refers to the accompanied drawings. The description does not limit the embodiments described herein.

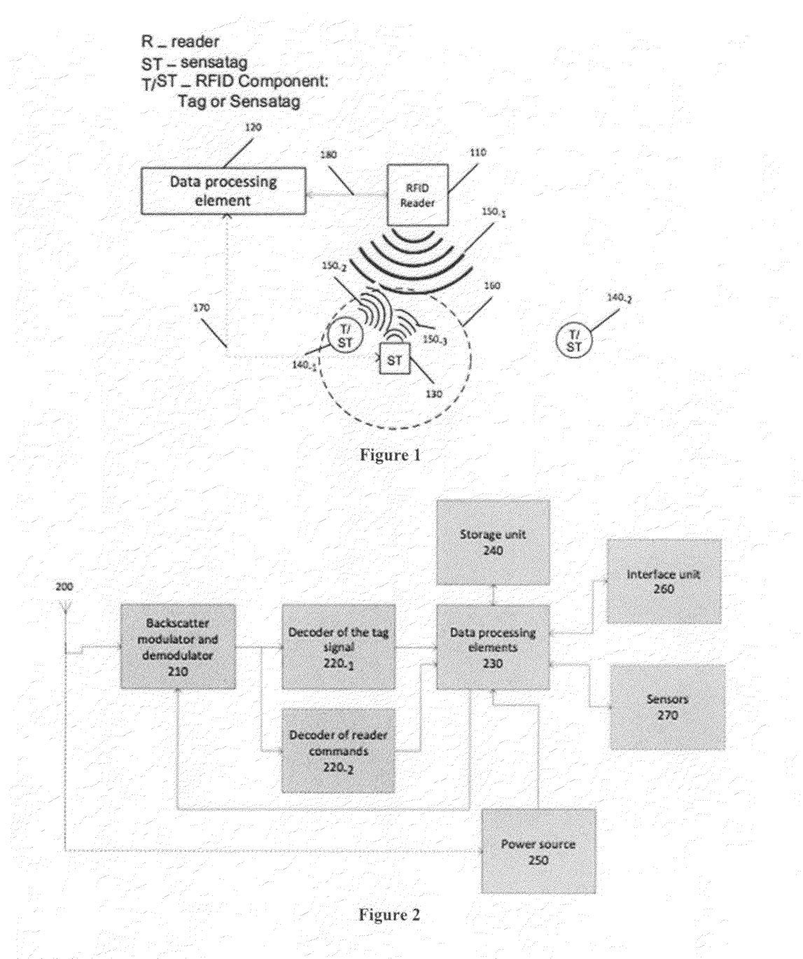

FIG. 1 is a block diagram of an exemplary system in which systems and methods described herein will be implemented. The system includes at least one RFID reader 110, at least one ST 130, at least one RFID component that can be an RFID tag or an ST (two RFID components 140-1 and 140-2 are presented in FIG. 1) and a data processing element 120.The data processing element 120 can be a personal computer or any other processing device. In FIG. 1, reader control, storing and processing information is all done in the same data processing element 120. In other instances, different computers or processing devices can be used for controlling the reader, storing and processing information.

The first embodiment is based on reader-talk-first RFID protocol. An example of such RFID protocol is EPCGlobal Class 1 Generation 2 air-interface protocol (ISO 18000-6C). In this protocol, the reader 110 starts reading tags that are in its reading range. The reader 110 sends a signal 150-1. The signal is received by the RFID components and STs and decoded. The RFID components start responding to the reader command by following a specific protocol. In FIG. 1, the RFID component 140-1 responds by sending its identification number (ID) to the reader 110. The ST 130 detects the signal 150-1 from the reader so that it is prepared to listen and decode signals from the RFID components. Since tag 140-1 is in the detection range, which is presented by the dotted circle 160 in FIG. 1, the ST 130 will detect the signal 150-2 from the tag 140-1. The signal from the tag 140-1 is decoded and temporarily stored in the ST 130.

In one implementation, the ST 130 is implemented to communicate with the reader using the same RFID protocol as an RFID tag. Therefore, ST 130 will then be addressed by the reader 110 and the stored tag's information together with the ST's ID will be backscattered to the reader. The reader 110 forwards the collected information from the tags and the STs to a data processing element 120 through wired or wireless link 180.

In another example implementation, the ST 130 has additional interface 170 that can be wireless or wired. Through that interface the ST 130 can send information directly to the data processing element 120 without going through the RFID reader 110. In this situation, the reader 110 queries only RFID tags and forwards the tag's information to the data processing element 120. The querying time will be shorter because the reader needs to query only tags but not STs. However, this embodiment requires having STs with two interfaces: one for receiving and decoding RFID communications and one for transmitting messages to the data processing element 120.

Another embodiment describes the tags-talk-first RFID protocol. An example of such protocol is ISO 18000-6d. In tag-talk-first and tag-talk-only protocols for passive and semipassive RFID system, the reader only provides a sine wave signal at fixed frequency that passive tags use for powering up and backscattering. In one implementation, the reader 110 will provide unmodulated RF signal 150-1 and tags in its reading range will start responding. Tag 140-1 responds by transmitting its own ID. If no other tags attempted communication at the same time, the reader 110 will be able to decode the tag's ID. The ST 130 detects the signal from the tag 140-1 that is in its reading range and stores the detected bitstream. As in the previous situation, the ST 130 can communicate either with the reader 110 using the same RFID protocol or directly with the data processing element 120 using any other supported wired or wireless protocol.

The RFID component 140-2 is outside the detection range of the ST 130 and therefore it will not be detected by the ST 130.

Even though this patent is mainly related to RFID systems in which communication is based on backscattering, similar concepts can be applied for other RFID systems such as active RFID tag systems. An example of such protocol is ISO 18000-7 (Dash-7). In one implementation, the ST listens and decodes communication between the RFID reader and the active tag and communicates this information to the reader using the same active RFID protocol. In another implementation, the ST listens and decodes the communication between the reader and the active tag and then transmits this information to the data processing unit using some non-RFID based protocol such as Wi-Fi or Ethernet.

The exemplary configuration illustrated in FIG. 1 is provided for simplicity. It should be understood that a typical system may include fewer or more devices than presented in FIG. 1. For example, the system can contain plurality of RFID readers that can all be connected to the same data processing element. The number of STs would depend on the application of interest and can be at minimum one. In one implementation, it would be possible that all the components in the system are STs. In this case, the RFID components 140-1 and 140-2 in FIG. 1 are STs as well. In such system, all the components in the system are capable of listening and detecting each other. The number of tags can range from zero up to a large number. Tags only communicate with the reader and they are detected by the STs.

Regarding the deployment of STs and RFID components, five different implementations are described. In implementation one, both ST 130 and RFID components (140-1 and 140-2) are placed at fixed locations that are recorded and considered known. Tags or STs placed at known locations -are referred as landmark tags. This deployment configuration can be used for localization and tracking of mobile readers such as the ones attached to forklifts. In implementation two, the RFID components (140-1 and 140-2) are attached to objects and people, and STs 130 are used as landmark tags. This deployment scenario can be applied to localization and tracking of objects, for preventing unwanted reading, 3D localization and tracking, and determining direction of motion. In implementation three, STs 130 are attached to objects and people and RFID components (140-1 and 140-2) are used as landmark tags. This deployment scenario can also be applied to localization and tracking of objects, for preventing cross reading, 3D localization and tracking, and determining direction of motion. In implementation 4, STs and tags are attached to people and objects and their locations are not fixed and not known. This deployment scenario can be used for proximity detection and can be applied, for example, for inferring social interactions. In implementation five, some or all of the previous deployment scenarios are mixed together.

FIG. 2 is a block diagram of an exemplary ST 130 which is used in the systems and methods described herein. The ST hardware includes an antenna 200 that is used for receiving the signals from RFID reader 110 and RFID components 140-1, a backscatter modulator and demodulator 210, a decoder of the tag's signal 220-1 and the reader signal 220-2, a data processing element 230, a storage unit 240, a power source 250, an interface unit 260, and sensors 270.

In one implementation, the ST is a passive or semi-passive device that can communicate with the reader using backscattered communication. The decoder of the RFID signal from the reader 220-2 and from the tag 220-1 can be implemented using, for example, an envelope detector. In exemplary implementation, matching circuit and Schottky diode-based detector can be used. The decoder of the reader signal 220-2 may be further implemented using a threshold comparator that is used to digitize the signal. The decoder of the tag backscatter 220-1 may consist of a band-pass filter (or a high-pass filter) for removing the DC offset, followed by a comparator that is configured as a data slicer. The filter parameters and the threshold generation circuit for the comparator are adaptive.

In another implementation, the decoder of the RFID signal from the reader 220-2 and from the tag 220-1 can be implemented using a standard radio in which the radio will be tuned to the frequency of the reader. In this implementation the ST 130 will be able to estimate more parameters besides the decoded bitstream from the RFID component 140-1 such as, for example, the RSS. The ability to estimate RSS may be useful as it may provide additional information for the localization algorithm.

The data processing element 230 runs a state machine for the RFID protocol. In addition, it runs the state machine for the ST. The data processing element 230 partially processes the baseband signal and in case where the decoder relies on radio, it uses A/D convertors to acquire the signal and perform baseband processing. The ST can be programmed in the data processing element 230 to detect only particular tags. In this case, the ST will report to the reader only when necessary, thereby reducing the amount of communication.

A preferred embodiment for the power source 250 is a battery. In another embodiment, the power can be obtained from the RFID reader signal 110 in which case the ST will act as a passive tag. When the ST communicates passively with the RFID reader but uses a battery for its circuitry, the ST acts as a semipassive RFID component. In yet another embodiment, when the ST is connected over the Ethernet, Power over Ethernet can be used to power the ST so that there is no need for batteries. In this case, the ST is used as a landmark tag. The advantage of using Power over Ethernet is that there is no need for battery for the ST and therefore no need for changing or recharging batteries and that additional complexity and processing power can be implemented in the ST since there the power limits are less stringent than the ones imposed by the capacity of the battery.

Regarding communication with the reader, in one embodiment the ST does not need to communicate wirelessly with the reader but it relies on using wired interface. In this case, the interface unit 260 can be implemented to support, for example, Ethernet. Therefore, there is no need for implementation of the wireless transmitter. The advantages of this configuration are that the RFID communication throughput is not reduced because of communication between STs and readers. In another embodiment, the ST communicates wirelessly but it does not need to communicate with the RFID readers using backscattered modulation. The interface unit 260 can be implemented to support some other wireless protocol such as, for example, Zigbee or Wi-Fi.

In one embodiment, STs are integrated with sensors 270 or wireless sensor nodes and we call them sensor-tag-is (ST-is). Sensors 270 may be used to detect different events that can be of interest for a particular application. For example, in the case of detection of social interactions, infrared sensor or voice detector can be incorporated with the ST to detect proximity and speech of people.

In FIG. 2, the dotted lines are used for blocks and lines that are optional. For example, decoder of reader command 220-2 is optional for tag-talk-first or tag-talk-only protocols. The decoder of reader commands 220-2 needs to be used for reader-talk-first protocols. The interface unit 260 is used only if the ST 130 does not communicate using the same RFID protocol with the RFID reader. If some other protocol is used, then the interface unit 260 is needed. If sensors are attached to the ST, then block 270 is needed.

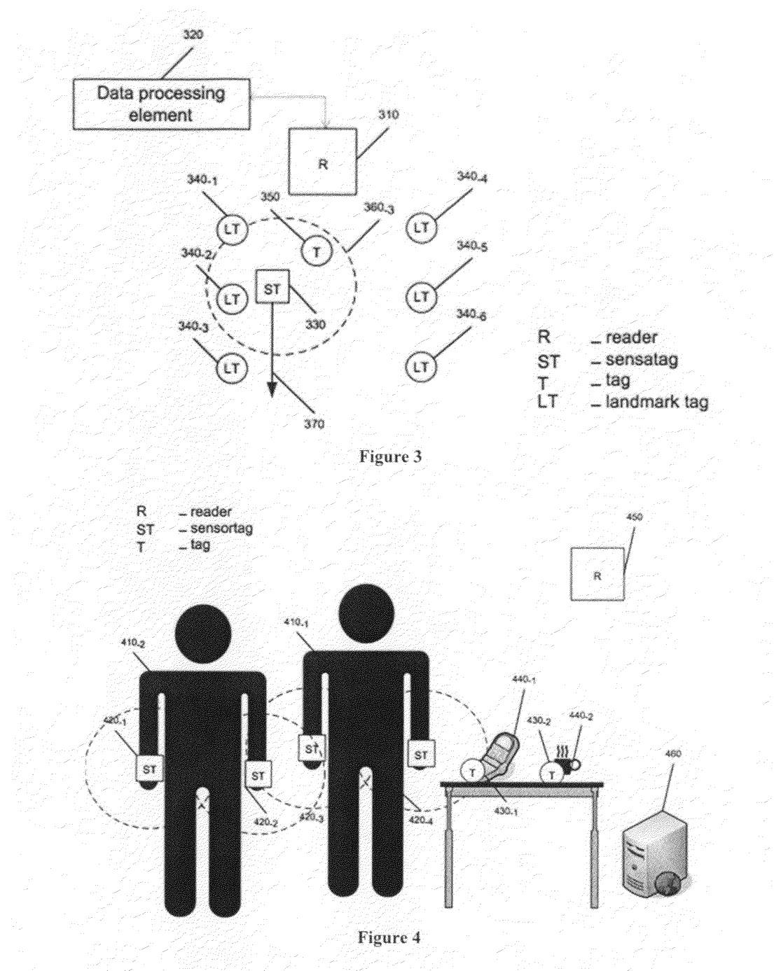

FIG. 3 displays an exemplary setup and a system for localization of STs using RFID tags placed at known locations. In this scenario, the ST 330 is mobile and can be attached to people and objects of interest. Tags placed at known fixed location are called landmark tags (LTs) 340-1, 340-2, . . . , 340-6. In one embodiment, we deploy passive tags and record their locations. Other implementation can use semipassive tags. In a third implementation, the landmark tags can be STs.

In one embodiment, the system is based on reader-talk-first protocol. The reader 310 sends a query signal and queries all the tags and landmark tags. In one implementation the ST 330 can be queried during the next query round when the tags are not queried. As a result of the queries, the data processing element 320 receives a list of STs and their associated tags with time stamps. The accuracy of the system depends on the density of the landmark tags 340 deployed at known locations. The algorithm in which the position of the ST 330 is detected based on association with multiple landmark tags can be applied. The position of the tag 350 is then determined based on the position of the ST 330.

Another embodiment of automated localization of items placed in stock is also shown. Suppose that a worker in a warehouse is bringing new items on a shelf and is putting them on it manually. The worker has an ST 330 that is, for example, attached as a wristband. The dotted circle displays the detection range of the ST. While placing the boxes on the shelf, the ST 330 detects all the communication that goes between the passive landmark tags (340-1 and 340-2) that are in the range of the ST 330 and the tags 350 on the boxes that are being stored with a nearby reader 310. The reader 310 can be stationary or mobile. This information when passed on to the data processing element 320 is sufficient to obtain the estimate of the locations of the old and new items on the shelves. A similar concept is applied in another embodiment where pallets are placed on shelves by forklifts, for example. In this case, the STs are placed strategically on the forklifts.

The application scenario presented in FIG. 3 is suitable for a large number of applications including:
Localization of objects and people in various environments including warehouses, hospitals, airports, libraries, stores, offices, and factories.
Tracking people carrying STs as, for example, badges in conferences and conventions.
Guiding people in known environments such as stores or conference centers.
Tracking more expensive or bulkier objects such as boxes in warehouses.

Another embodiment includes 3D localization. In this application, landmark tags 340-1 to 340-6 can be either STs or regular tags placed at known locations in three dimensions.

In yet another embodiment, a direction of motion is determined. Direction of movement of the ST 330 is shown using an arrow 370. At a given time instant, the ST detects the landmark tags 340-1 and 340-2. As it keeps moving, the ST will not be able to detect the tag 340-1 any more, but it will start detecting 340-3. Based on the changing association between the landmark tags and the STs in time, the data processing element 320 determines direction of movement of the object.

FIG. 4 is a block diagram of an exemplary system that is used for proximity detection. FIG. 4 describes a system that can be used for detecting proximity between people and between people and objects. Another implementation of this system can be used for detecting proximity among objects. For proximity detection, the locations of the STs and tags are not known in advance and are not important.

FIG. 4 describes a system where the RFID tags 430-1 and 430-2 are placed on objects of interest such as a phone 440-1 and a cup 440-2. The STs are placed on people. In this example, the STs 410-1, 410-2, 410-3 and 410-4 are placed on wrists of two people 410-1 and 410-2. In another instance of the application, only one ST per person can be used. The STs can be connected to wrists, placed around the neck, in the pockets or at any other convenient place on the body or clothes. The system further includes one long range RFID reader 450 and a data processing element 460 that is a personal computer in this case.

Tag 430-1 is in the range of the ST 420-4. In one embodiment the reader 450 would send a query and the tags will reply. When the tag 430-1 replies, its signal is detected and stored by the ST 420-4. This information is sent to the reader 450 in the next query round and then to the data processing element 460. In the processing element 460, the duration of the detection and the quality of the detection can be computed. An example of how quality of detection can be estimated is to compute the ratio between the number of times the ST detected the tag and the number of reader queries.

The STs 420-2 and 420-3 are in the detection range of one another and they will be able to detect each other's signals and report that information to the reader 450. Again, in the processing element 460, the duration of the detection and the quality of the detection can be computed. If the duration and quality are above a predefined threshold, the data processing element might conclude that individuals 410-1 and 410-2 are engaged in a social interaction.

The exemplary configuration illustrated in FIG. 4 is provided for simplicity. It should be understood that a typical system may include fewer or more devices than presented in FIG. 4. In one embodiment, the ST can be attached to objects so that the system can detect proximity and interaction among objects. In another embodiment, the tags can be applied to sensitive objects such as blood samples, dangerous chemicals or explosive devices and the STs can be placed on wrists of people dealing with these objects. Since the interaction between people and objects is recorded, it is possible to automatically update the record of people who were dealing with the sensitive items. In yet another embodiment that covers interaction among people and objects, the system can be applied for tracking daily activities of people. The STs can be again placed on people's wrists and tags on the objects of interest. Tracking daily activity of people is based on the analysis of their behavioral patterns that are evaluated by accessing which objects people interact with.

The scenario from FIG. 4 can also be extended to tracking social interaction among people and may include more than two individuals. Tracking social interaction can be used for health and educational applications, for example knowing who interacts with whom when group learning is exercised. Additional sensors such as infrared or voice detector may be added to the ST to improve detection of interaction among people.

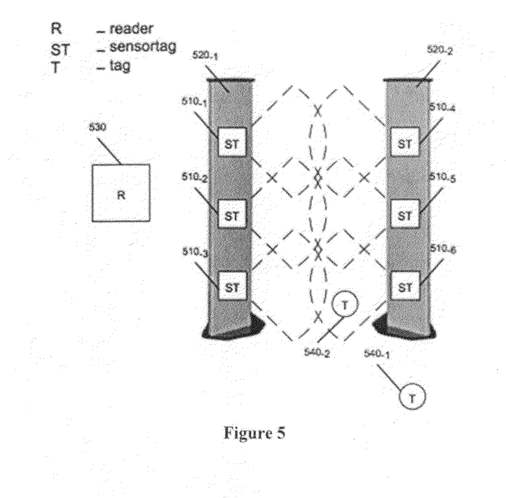

FIG. 5 is a block diagram of an exemplary system that is used for preventing unwanted reads. The figure shows a portal application. By using STs in portal applications, it would be possible for the reader to transmit signals from the reader antenna at full power and therefore to increase the chance of reading passive tags inside the portal. However, preventing unwanted reads is not by any means limited to a portal application. This embodiment includes any application that requires RFID readers to read reliably in a well-defined bounded area.

The portal in FIG. 5 is composed of two antenna panels 520-1 and 520-2 that contain one or more reader antennas. The panels are placed so that they point to one another. The reader antennas are connected to the reader 530. In FIG. 5, only one reader is presented and it controls the antennas in both panels. Implementations with multiple readers and with more than two panels are also possible. The STs are placed on the antenna panels in this implementation. The STs 510-1, 510-2 and 510-3 are placed on the panel 520-1 and the STs 510-4, 510-5 and 510-6 are placed on the panel 520-2. In another embodiment, the STs can be placed next to the antenna panels. The detection range of each ST is presented by dotted lines. The data processing element is not shown in FIG. 5, but it is assumed that it exists. The tags 540-1 and 540-2 are attached to objects and/or people of interest. In FIG. 5, The ST 540-2 is detected by the reader and by the ST 510-6. As such, the tag 540-2 will be registered by the system. Tag 540-1 may be read by the reader antennas 520-1 and 520-2, but it is not detected by any of the STs. Therefore, the data processing element will consider the reading of the tag 540-1 as unwanted read and it will not register that reading.

The STs 540-1, . . . , 540-6 can be implemented so that they have Ethernet connection and can be powered over Ethernet. There are several reasons for that. First, a number of tags that are moving through the portal can be very large and all the tags need to be scanned quickly. Therefore, it is very important not to waste bandwidth on RFID communication between the ST and the RFID reader. The number of STs placed on the portal will be small and therefore use of somewhat more expensive STs is acceptable.

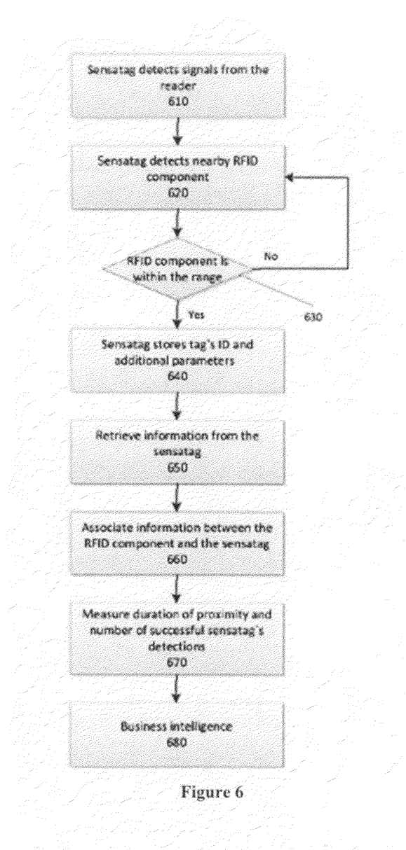

FIG. 6 displays an exemplary method for determining proximity. The method can be applied to both reader-talk-first and tag-talk-first systems. In reader-talk-first systems, the reader sends a query signal first, while in talk-talk-first systems the reader will send only an unmodulated wave. We refer to the system from FIG. 1. The ST 130 detects the signal from the reader 110, step 610, and adjusts its parameters in case of reader-talk-first-protocol. In addition, the ST 130 sets its state in expecting signals from the tags or other STs. In the next step, 620, the ST 130 detects the signal from the tag 140-1 that is in its range. The detection range 160 of the ST 130 is programmable. If the response from the signal is within the set boundaries, step 630, the ST 130 will register the tag and store its ID, step 640. The ST may record additional parameters such as, for example, received signal strength from the tag.

The information recorded by the ST 130 needs to be retrieved by the data processing element 120, step 650. Several possible communication scenarios are presented by using FIG. 1. The STs can communicate with the readers using the same RFID standard as it is used for reader-to-tag communication. In this case, the ST 130 may be queried by the reader 100 and the ST 130 will provide recorded information to the reader 110. This information will be forwarded from the reader 110 to the data processing element 120. In another embodiment, the communication will occur through another wired or wireless interface and the information will be transferred from the ST 130 to the data processing element 120.

In the next step 660, the tag's IDs queried directly by the reader 110 and the IDs detected by STs are associated. Association is an indicator of proximity detection. Next, in the step 670, the duration of association as well as the percentage of successful detections of the tag 140-1 by the ST 130 are determined. These parameters are used for more robust determination of proximity. In addition, the detection of duration of association can be used to infer about social interactions among people. Further analysis of the data in the context of current application is done in a step called harvesting business intelligence 680. Information about proximity detection needs to be converted into useful events and information for a particular application. For example, proximity detection among STs on people wrists and objects can be used to infer about daily activities of elderly people.

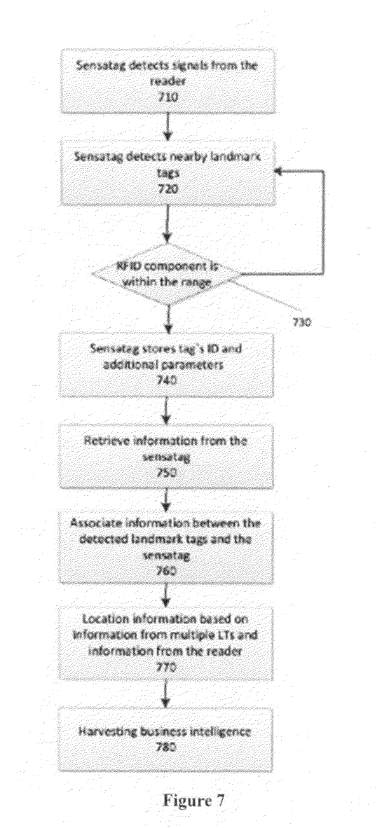

FIG. 7 displays an exemplary method for localization. In this example, the STs are attached to the objects or people that need to be located and RFID components (tags or STs) are used as landmark tags. Steps 710 -760 are the same as steps 610-660 in FIG. 6. The only difference is in step 720 where the STs detect RFID components that are at the fixed locations while in 620 location of STs and tags were not known. Association information between a tag and multiple landmark tags can be used to estimate location, step 770. The percentage of detection of landmark tags by the ST is information that can be used for improved localization, Tracking is achieved by using the same strategy except that now the processing element takes into account the times of the associations between a tag and multiple landmark tags.

Harvesting business intelligence is performed in the next step, 780. One example application is for counting the number of occurrences based on localization information. In one implementation, this is used for determining the number of people in front of a particular place (for example in an aisle in convention centers and fairs). In another implementation, this information is used for determining the number of time an object is examined in front of shelves. In yet another implementation, localization information is used for collecting statistics on people's behavior in stores by placing landmark tags on the floor of supermarkets and STs on carts.

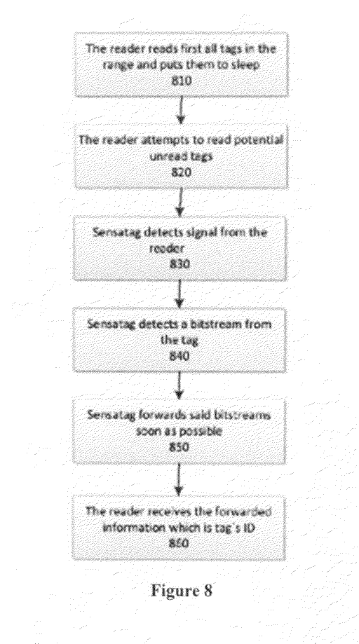

FIG. 8 displays an exemplary method for improving read rates. The method can be applied to both reader-talk-first and tag-talk-first systems. In reader-talk-first systems, the reader sends a query signal first, while in talk-talk-first systems the reader will send only an unmodulated wave. We refer to the system from FIG. 1. The method from FIG. 8 is described for the ISO 18000-6C protocol. However, it is not limited only to this protocol.

In the first step, 810, the reader 110 tries to read all the tags without the assistance of the STs. The tags that are read will not be active in the next query round. In the next query round, step 820, the reader 110 will send another query to attempt to read the remaining tags. The ST will detect the signal from the reader and will know during what round it needs to be active, step 830. Suppose that tag 140-1 was not read in the first query round because its response was too weak to be readable by the reader. The tag 140-1 will respond in the second round and its response will be read by the ST 130, step 840. In one implementation, the bitstream from the tag 140-1 detected by the ST will be forwarded as soon as it is detected by the ST to the reader using backscattered modulation, step 850. The signal from the ST may be stronger than the tag signal by using, for example, a semipassive ST. The information will be received by the reader, which will detect tag 140-1 in this case, step 860. In another implementation, detected bitstream from the ST will be forwarded to the data processing element using a non-RFID interface, step 850. This method is more suitable for tag-talk-first protocols.

### CONCLUSIONS

The presented embodiments show an RFID system with an additional component (ST) whose functionality is significantly extended because of the ST and new methods/algorithms. The applications of this new system include localization, tracking, determining direction of movement, determining proximity of people or other objects, reducing unwanded reads and improving read rates.

While the above description contains many specificities, these should not be construed as limitations on the scope of the invention, but rather as an exemplification of preferred embodiments thereof. Many other variations are possible. For example, systems for proximity detection, localization, and tracking can be combined so that proximity between people and objects of interest can be determined together with their positions. The proposed ST and RFID system can be used as a backbone for “Internet of things” because it enables several of major features of Internet of things including: intelligence of the objects, ability of interaction between the objects and with people, ability of self-localization and localization of other objects that they detect. In addition, the ST can be used as a protocol analyzer because it collects signals from both tags and readers. The ST can also be used to assist in deployment of UHF RFID systems because of its ability to collect signals from the readers and tags. Accordingly, the scope of the invention should be determined not by the illustrated embodiments, but by the appended claims and their legal equivalents.

1. A radio frequency identification (RFID) system comprising:
a) an RFID reader for communicating with RFID components (where RFID component is a tag or a sensatag) and decoding information from said RFID components;
b) at least one said RFID component for communicating with said RFID reader using means of passive backscatter modulation;
c) at least one said sensatag for receiving a signal from said RFID component, demodulating said signal and extracting the information from said RFID component that includes bitstream and relevant parameters, and communicating said received information;
d) a data processing element for processing said information obtained by said RFID reader and said information obtained through said sensatags,
whereby said RFID system can be used for localization, proximity detection, improving read rates, reducing unwanted reads, and making inference from sensor data.

2. A method for establishing association between sensatags and RFID components comprising:
a) receiving communication between said RFID reader and at least one said RFID component at said at least one sensatag;
b) decoding the backscattered signal from said RFID component ;
c) determining if said RFID component that communicated with said RFID reader is in a predefined range of said sensatag;
d) communicating said information by said sensatag obtained from said RFID components;
e) associating information of said RFID component read by said RFID reader and with the information detected by said sensatag in said data processing element.

3. A method for improving read rates comprising:
a) receiving bitstream from at least one said RFID component (whose signal cannot be properly decoded by said RFID reader) at said at least one sensatag;
b) forwarding detected said bitstream by said sensatag to said RFD reader;
c) processing obtained bitstream by a data processing element comprising of extraction of said information from said sensatag to obtain the bitstream that was transmitted by said RFID component and processing said bitstream to obtain information about said RFID component that was not detectable by said RFID reader.

4. An RFID system of claim 1 wherein said sensatag component communicates its information to said RFID reader using the same RFID communication protocol that is used for communication between said RFID reader and said RFID tag and said RFID reader forwards information to said data processing element.

5. An RFID system of claim 1 wherein said sensatag component communicates its information directly to said data processing element using wireless communication protocols not based on RFID backscatter modulation or by communicating through a wired link.

6. An RFID system of claim 1 wherein the sensatag is integrated with at least one sensor (sensatag-is) with additional functionality of receiving signals from said sensor and extracting information from said signals.

7. A method for establishing association of claim 2 wherein RFID components are used as infrastructure components (landmark tags) placed at known fixed locations and sensatag components (sensatags and sensatags-is) are attached to objects and/or people to be located.

8. A method for establishing association of claim 7 wherein processing includes the substeps of:
a) determining what said RFID components are detected by said sensatag components;
b) estimating position of said sensatag component based on known position of said RFID components,
whereby this method is used for localization of sensatag components.

9. A method for establishing association of claim 8 wherein processing includes the substeps of:
a) combining information from multiple sensatag components to further improve localization accuracy;
b) combining information from the RFID reader as well as additional parameters to further improve localization accuracy.

10. A method for establishing association of claim 7 further comprising of steps of:
a) plurality of landmark tags (tags or sansatag components) are deployed at known fixed places in a given area and their coordinates are recorded;
b) information from plurality of said landmark tags is analyzed sequentially in time to determine direction of movement of the identified said tag or said sensatag component.

11. A method for detecting association of claim 2 comprising:
a) placing said sensatag components in strategic places and said RFID components on objects or people that need to be detected and/or located;
b) processing in said data processing element with the purpose of removing unwanted reads that includes accepting RFID component reading only if said RFID component is detected by said reader and also detected by said sensatag component,
whereby this method can be used to prevent unwanted reads.

12. A method for detecting association of claim 2 wherein processing includes the substeps of:
a) inferring proximity between RFID components and sensatags based on association information;
b) combining said association information with additional said parameters obtained from said reader and said sensatag component,
whereby the method is used to detect proximity between people and objects, among objects themselves, or among people themselves.

13. A method for detecting association of claim 12 wherein the sensatags are attached to people and the processing step includes the sub-step of determining interaction between plurality of people based on measurement of duration of proximity among said people,
whereby it can be used for monitoring social interactions.

14. A method for detecting association of claim 2 wherein processing stages of sensatag-is further include:
a) receiving signal from integrated sensors by the sensatag;
b) if necessary preprocessing the said sensor signals by the sensatag;
c) communicating the received sensor signals or preprocessed signals from said sensatag-is to said RFID reader;
d) forwarding received information by said RFID reader to said processing element;
e) receiving the said information from said processing element and processing it together with information from possibly a plurality of sensatags-is,
whereby localization, proximity detection, detection of movement and reducing unwanted reads can be further improved by including additional sensor data.

15. A method for detecting association of claim 2 wherein processing stages of sensatag-is further include:
a) receiving signal from integrated sensors by the sensatag;
b) if necessary preprocessing the said sensor signals by the sensatag;
c) communicating the received sensor signals or preprocessed signals from said sensatag-is to said data processing element using non-RFID protocols;
d) receiving the said information from said processing element and processing it together with information from possibly a plurality of sensatags-is,
whereby localization, proximity detection, detection of movement and reducing unwanted reads can be further improved by including additional sensor data.

16. The method for improving read rates of claim 3 wherein the sensatag is capable of listening and decoding the signal from said RFID component and forwarding the bitstream from said tag to said RFID reader using the same RFID protocol where said RFID reader will obtain stronger signal from said sensatag component, decode it and forward to said data processing element.

17. The method for improving read rates of claim 3 wherein the sensatag is capable of listening and decoding the signal from said RFID component and forwarding it to said data processing element immediately as it receives the signal from said RFID component using a separate communication channel.
